(19) United States
(12) Patent Application Publication
(10) Pub. No.: US 2017/0170934 A1
(43) Pub. Date: Jun. 15, 2017

(54) Method and System for Exchanging Application Data Between a Console Device and one or More Remote Devices over WLAN Network

(71) Applicant: Wipro Limited, Bangalore (IN)

(72) Inventor: Naveen Kumar JEYACHANDRASEKAR, Tiruchirapalli (IN)

(21) Appl. No.: 15/008,140

(22) Filed: Jan. 27, 2016

(30) Foreign Application Priority Data
Dec. 11, 2015 (IN) 6650/CHE/2015

(51) Int. Cl. H04L 5/00; H04W 76/02

(52) U.S. Cl. CPC H04L 5/0048; H04W 76/02; H04W 84/12

(57) ABSTRACT

The present disclosure relates to a method and system for exchanging application data between a console device and one or more remote devices over WLAN network. In an embodiment, the console device places the application data in at least one of a probe request frame and a probe response frame. The console device further performs a data processing event on at least one of the probe request frame and the probe response frame, wherein the data processing event includes receiving the probe request frame from the one or more remote devices and transmitting the probe response frame to the one or more remote devices. Furthermore, the console device forwards the application data to an application installed in the console device, upon receipt of the probe request frame from the one or more remote devices.

### TECHNICAL FIELD

The present subject matter is related, in general to data exchange in a wireless communication network, and more particularly, but not exclusively to a method and system for exchanging application data between a console device and one or more remote devices over WLAN network.

### BACKGROUND

Wireless communication networks typically include wireless access nodes (or Access Points), through which one or more wireless communication devices (or stations) can register and receive wireless communication services. The wireless communication network also transfers information to the wireless communication devices through the wireless access nodes. According to IEEE 802.11 wireless local area network (WLAN) standard, an Access Point (AP) allows wireless communication devices to connect to a network and controls network management of all communication devices.

One of the conventional techniques discloses a method in which the transmitting device permits transmission of application-specific data through a specific field in a beacon frame i.e the Service Set Identity (SSID). The data transmission takes place by implementing a Broadcasting Scheme (NBS) Processor in the transmitting device and a NBS Parser in the one or more receiving devices. The transmitting device can broadcast application specific data while the one or more receiving devices can automatically act upon the receipt of the broadcasted application specific data.

However, there are scenarios in which a plurality of wireless communication devices (or remote devices), need to exchange application data without requiring a connection(or association) with the wireless access node (AP). For example, in testing of a WLAN communication device, such as laptops, mobile phones, etc., one or more configuration details may have to be transmitted to the wireless communication device to perform various actions as per a predetermined test case procedure. Hence, it is required that each of the participating remote devices transmit one or more communication frames to the console communication device for completing the predetermined test case procedure. Another example is inventory tracking, where the inventory details of one or more wireless communication devices have to be collected. In such cases, it is preferable for the remote devices to have the ability to exchange data, without requiring a connection with the wireless access node (or AP). Also, having a one to one connection with the remote device may become cumbersome especially if the number of remote devices is large.

The issue mainly faced during the exchange of application data between a console device and one or more remote devices over WLAN network is the inability of the remote devices to exchange the data with the console device without requiring a connection with the wireless AP.

### SUMMARY

Disclosed herein is a system and method for exchanging application data between a console device and one or more remote devices. A communication session is established between the console device and the one or more remote devices using a probe request frame and a probe response frame. The console device uses the established communication session to transmit the application data to the one or more remote devices using at least one of a probe request frame and a probe response frame. The console device also receives the application data from the one or more remote devices using at least one of the probe request frame and the probe response frame. Also, the one or more remote devices may initiate the communication and transmit the application data to the console device.

Accordingly, the present disclosure relates to a method for exchanging application data between a console device and one or more remote devices. The method comprises placing, by the console device, the application data in at least one of a probe request frame and a probe response frame. The console device further performs a data processing event on at least one of the probe request frame and the probe response frame, wherein the data processing event includes receiving the probe request frame from the one or more remote devices and transmitting the probe response frame to the one or more remote devices. The console device forwards the application data to an application installed in the console device, upon receipt of the probe request frame from the one or more remote devices.

Further, the present disclosure relates to a console device for transmitting the application data to one or more remote devices. The console device comprises a processor and a memory communicatively coupled to the processor. The memory stores processor-executable instructions, which, on execution, causes the processor to perform one or more actions. The one or more actions include placing the application data in at least one of a probe request frame and a probe response frame. The instructions further cause the console device to perform a data processing event on at least one of the probe request frame and the probe response frame. The data processing event includes receiving the probe request frame from the one or more remote devices and transmitting the probe response frame to the one or more remote devices. The console device forwards the application data to an application installed in the console device, upon receipt of the probe request frame from the one or more remote devices.

Furthermore, the present disclosure relates to a non-transitory computer readable medium including instructions stored thereon that when processed by at least one processor cause a console device to perform the acts of placing the application data in at least one of a probe request frame and a probe response frame. The instructions further cause the console device to perform a data processing event on at least one of the probe request frame and the probe response frame, wherein the data processing event includes receiving the probe request frame from the one or more remote devices and transmitting the probe response frame to the one or more remote devices. The console device forwards the application data to an application installed in the console device, upon receipt of the probe request frame from the one or more remote devices.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 shows an exemplary environment illustrating method for exchanging application data between a console device and one or more remote devices in accordance with some embodiments of the present disclosure;

FIG. 2a shows a block diagram illustrating a console device in accordance with some embodiments of the present disclosure;

FIG. 2b shows a detailed block diagram illustrating an interaction between the console device and the remote device in accordance with some embodiments of the present disclosure;

FIGS. 3a and 3b show structure of probe request frame and probe response frame used for exchange of application data in accordance with some exemplary embodiments of the present disclosure;

FIGS. 4a and 4b show the sequence diagrams illustrating method for authenticating the remote device with the console device in accordance with some exemplary embodiments of the present disclosure;

FIG. 4c shows a sequence diagram illustrating state transitions and a method for establishing a communication session between the console and the remote device in accordance with some exemplary embodiments of the present disclosure;

FIG. 4d shows a sequence diagram illustrating a method of exchanging application data between the console device and the remote device in accordance with some exemplary embodiments of the present disclosure.

FIGS. 4e and 4f show sequence diagrams for establishing a communication session and exchanging application data between the remote device and the console device in accordance with an alternative embodiment of the present disclosure;

FIG. 5 illustrates a general flowchart showing method of exchanging application data between a console device and one or more remote devices in accordance with some embodiments of the present disclosure;

FIG. 6 illustrates a flowchart showing method of exchanging application data between a console device and one or more remote devices in accordance with some embodiments of the present disclosure; and

FIG. 7 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a method and system for exchanging application data between a console device and one or more remote devices over the WLAN network. In an embodiment, the console device places the application data in at least one of a probe request frame and a probe response frame. The console device further performs a data processing event on at least one of the probe request frame and the probe response frame, wherein the data processing event includes receiving the probe request frame from the one or more remote devices and transmitting the probe response frame to the one or more remote devices. Furthermore, the console device forwards the application data to an application installed in the console device, upon receipt of the probe request frame from the one or more remote devices.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

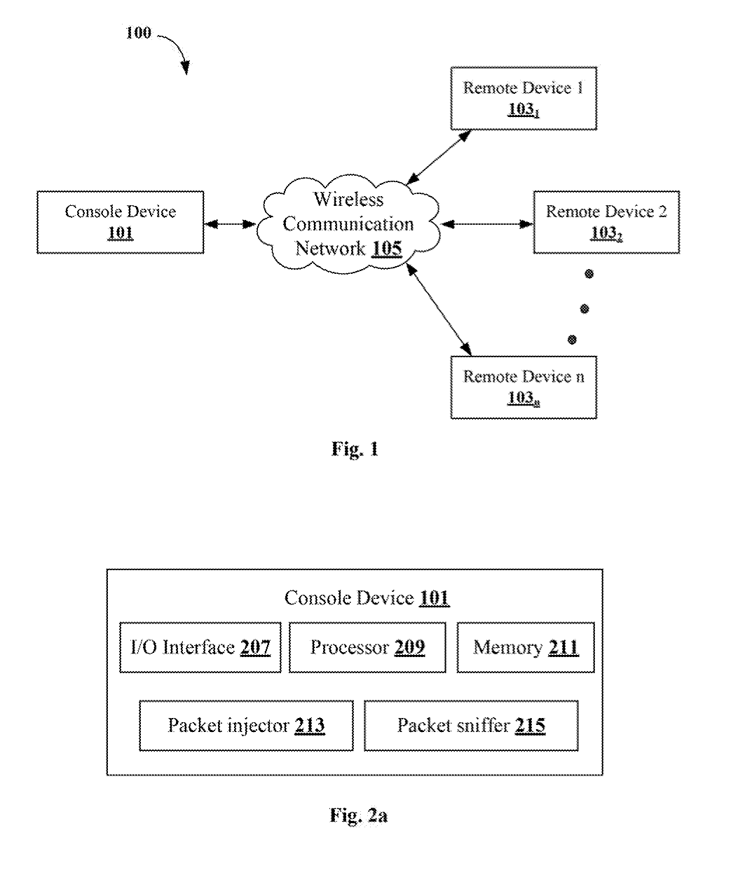

FIG. 1 shows an exemplary environment for exchanging application data between a console device and one or more remote devices in accordance with some embodiments of the present disclosure.

The environment 100 comprises of a console device 101, one or more remote devices, remote device 1 103₁ to remote device n103n (collectively referred as remote devices 103) and a wireless communication network 105. As an example, the console device 101, may include, but not limited to, a personal computer, a mobile phone, a tablet and a server. The one or more remote devices 103, may include, but not limited to, a sensor, a smart home appliance, a mobile phone, a wireless network printer and a personal digital assistance (PDA) device. The wireless communication network 105, may include, but not limited to, an infrastructure network, a bridge network, a peer-to-peer network and a wireless distribution system. In an embodiment, the console device 101 and the one or more remote devices 103 are network devices that operate under Institute of Electrical and Electronics Engineers (IEEE) 802.11 wireless communication standard specifications. IEEE 802.11 is a set of Media Access Control (MAC) and Physical layer (PHY) specifications for implementing WLAN computer communication in 2.4 GHz, 3.6 GHz, 5 GHz, and 60 GHz frequency bands. In an embodiment, the console device 101 and the one or more remote devices 103 use the wireless communication network 105 to exchange application data.

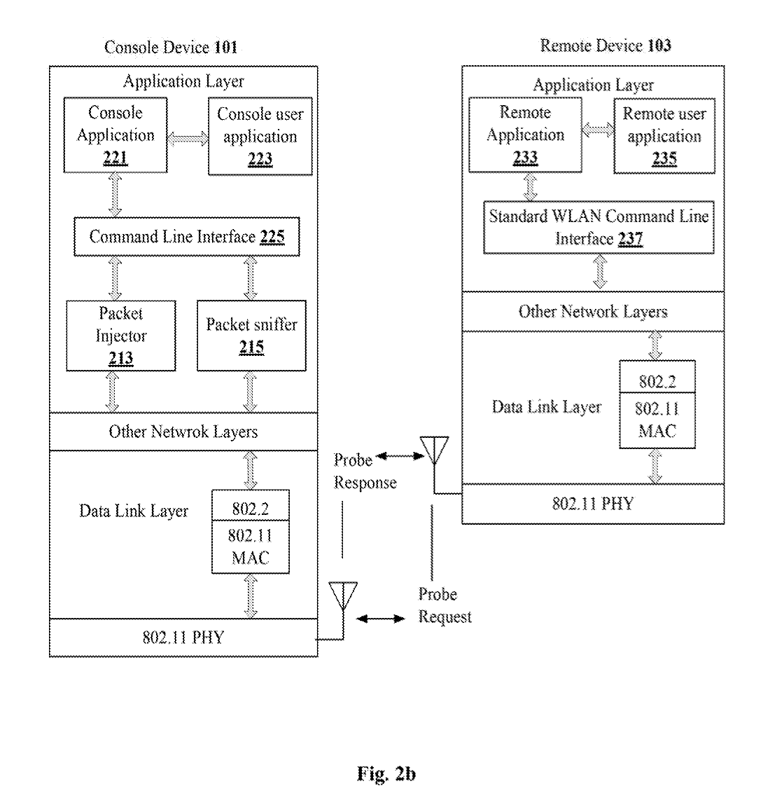

FIG. 2a shows a block diagram illustrating a console device in accordance with some embodiments of the present disclosure.

The console device 101 comprises an I/O interface 207, a memory 211, a packet injector 213, a packet sniffer 215 and a processor 211. The I/O interface 207 is configured to receive one or more commands and application data from the console user application 223 associated with the console device 101. The memory 211 is communicatively coupled to the processor 209. In an embodiment, the processor 209 may identify at least one of the one or more remote devices 103 based on media access control (MAC) address and unique identifier associated with each of the one or more remote devices 103. The processor 209 further comprises placing the one or more application data on at least one of a probe request frame and a probe response frame using the packet injector 213 and receiving at least one of probe request frame and a probe response frame using packet sniffer 215. The functionalities of packet injector 213 and packet sniffer 215 modules are explained briefly in the below section FIG. 2b.

FIG. 2b shows a detailed block diagram illustrating an interaction between the console device and the remote device in accordance with some embodiments of the present disclosure.

In an embodiment, the console device 101 exchanges one or more application data with the one or more remote devices 103 by using at least one of a probe request frame and a probe response frame over a wireless communication network 105. The console device 101 comprises a console application 221, a console user application 223, a Command Line Interface (CLI) 225, a packet injector 213 and a packet sniffer 215.

In an embodiment, the console application 221, the console user application 223, the command line interface 225, the packet injector 213 and the packet sniffer 215 may be configured in the application layer of Internet Protocol Suite (TCP/IP) or Open Systems Interconnection (OSI) communication model. The application layer provides services for the one or more applications, listed hereinabove, and ensures an effective communication of these applications with one or more other application programs in the wireless communication network 105.

In an embodiment, the console application 221 is the main controller program on the console device 101 which performs the action of authenticating the one or more remote devices 103, managing the one or more remote devices 103, establishing the communication session, transmission and retransmission of application data, etc. The console application 221 may receive one or more commands and application data from the one or more users associated with the console device 101. Further, the console application 221 may also transmit the received commands and application data to the one or more remote devices 103. The console application 221 also sends the application data received from the one or more remote devices 103 back to the one or more console user applications 223 associated with the console device 101.

In an embodiment, the one or more console user applications 223 may be used for performing one or more actions such as receiving and transmitting the application data to and from the one or more remote devices. As an example, the action may be sending and receiving a text message to and from one of the one or more remote devices 103.

In an embodiment, the command line interface (CLI) 225 is a user interface associated with the console device 101. The console user application 223 may use the CLI 225 to respond to a visual prompt by typing a command on a specified line and to receive a response back from the processor 209. The CLI 225 assists in a quick and easy interaction of one or more console user applications 223 with the one or more modules of the console device 101.

In an embodiment, the packet injector 213 associated with the console device 101 enables injecting a specific IEEE 802.11 standard packet, such as a probe response frame over the wireless communication interface 105. The packet injector 213 may also allow the one or more console user applications 223 to modify the content of the frames before transmitting it over the wireless communication interface 105. The console application 221 interacts with the packet injector 213 to build at least one of the probe response frame and a probe request frame with specific content and to transmit them over the wireless communication interface 105.

In one implementation, the packet sniffer 215 associated with the console device 101 captures the packet frames, such as a probe request frame over the wireless communication interface 105. The packet sniffer 215 captures the one or more frames upon receiving one or more instructions by the console application 221. The packet sniffer 215 also helps in analyzing the one or more captured frames to identify one or more specific fields within the captured frames. As an example, the one or more specific fields within the captured frame may include, a command ID field for determining sequence of transmitted application data, a Fragment ID field for indicating fragment number and number of pending fragments in the application data to be transmitted and a Session ID field for indicating the Session ID corresponding to the established communication session. In an exemplary embodiment, the console device 101 may interact with an Access Point (AP) via the Command Line Interface 225 for the purpose of packet injection and packet sniffing.

In an exemplary embodiment, the console user application 223 associated with the console device 101 may have one or more application data to be transmitted to the remote device 103. The command line interface 225 may receive the data from the console user application 223 and forward it to the packet injector 213 module in the console device 101. The packet injector 213 may convert the received data into one of the probe request frame and the probe response frame and inject the frame into the network 105. Further, one of the probe request frame and probe response frame injected in the network 105 traverses through one or more layers of the network 105 before reaching the remote device 103.

In an embodiment, each of the one or more remote devices 103 may be configured with a remote application 233 and a standard WLAN command line interface 237 for performing one or more actions, similar to the actions performed by the console device 101. In an embodiment, the remote application 233, remote user application 235 and the Standard WLAN CLI 237 of the remote device 103 may be configured to operate in the application layer of the TCP/IP layer model.

In an embodiment, the remote application 233 associated with the remote device 103 is the main controller program on the remote device 103 similar to the console application 221 on the console device 101. The remote application 233 performs the action of authenticating with console device 101, establishing the communication session, maintaining the status of the remote device 103, transmission and retransmission of application data, etc.

In an embodiment, the one or more remote user applications 235 associated with the one or more remote devices 103 perform actions of transmitting the application data to the one or more console devices 101 and receiving the application data from the one or more console devices 101. In an exemplary embodiment, the remote device 103 may be a sensor device deployed in a predetermined location for monitoring the location. The remote application in the remote device 103 may be configured to collect the one or more data associated with the location. The one or more data collected from the location may include, but not limited to, temperature of the location and moisture content in the location. Upon collecting the data, the remote application may forward the collected information to a console application 221 using at least one of the probe request frame and the probe response frame. The console device 101, upon receiving the information, may perform one or more actions on the received data as per one or more instructions from the console application 221.

In an embodiment, the standard WLAN command line interface 237 associated with the remote device 103 is a WLAN CLI 237 supported by the remote device 103. The standard WLAN CLI 237 is used to scan the wireless communication interface 105 for at least one of the probe request frame and the probe response frame transmitted by the console device 101. The standard WLAN CLI 237 is also used to transmit at least one of the probe request frame and the probe response frame with a specific Service Set Identifier(SSID), as specified by the remote application 233.

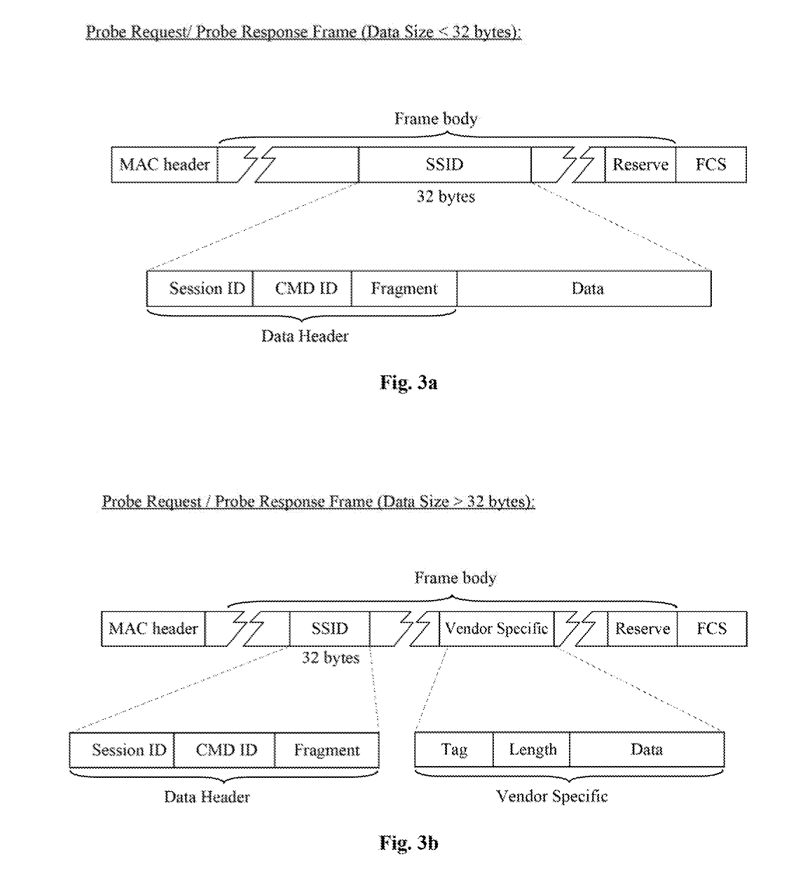

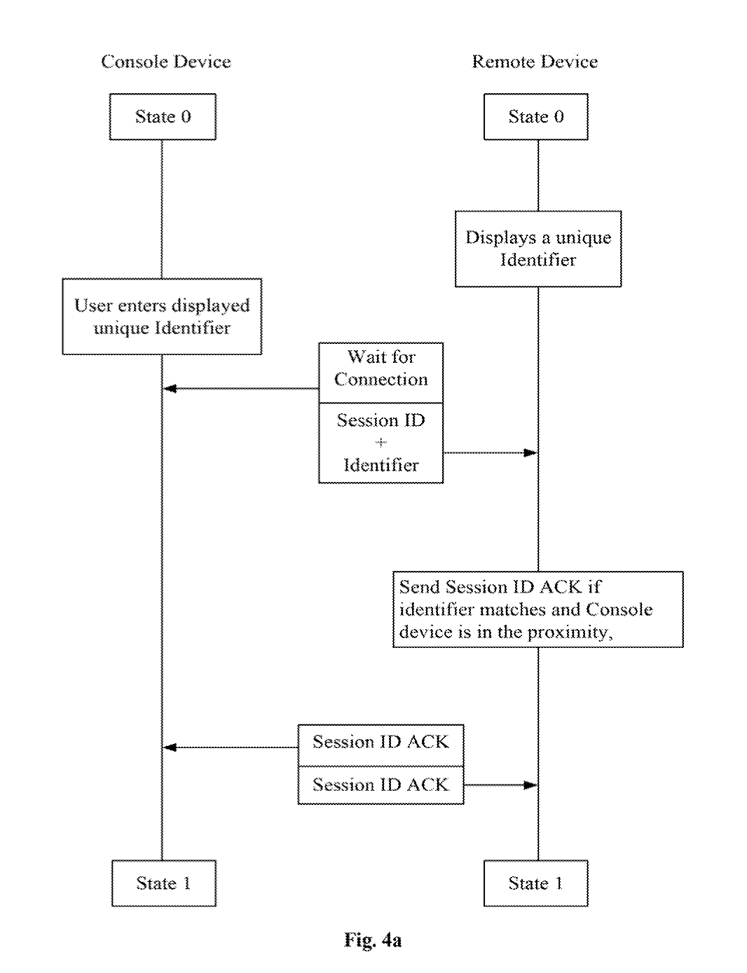

FIGS. 3a and 3b show structure of probe request and probe response frames used for exchange of application data in accordance with some exemplary embodiments of the present disclosure.

In an embodiment, the probe request frame and the probe response frame maybe exchanged between a console device 101 and one or more remote devices 103. As shown in FIG. 3a, the probe request frame in general comprises Media Access Control (MAC) header, Frame body and Frame Check Sequence (FCS) fields. The Service Set Identification (SSID) field within the Frame body in general is used to carry the Service Set Identifier information of the Basic Service Set (BSS). In an embodiment, the SSID field is a 32 bytes field which is directly accessible to the one or more console user applications 223 and remote user applications 235 through the CLI 225 and WLAN CLI 237. As an example, the WLAN CLI 237 used may be “iwlist” tool. Iwlist is a collection of user-space utilities written for Linux kernel-based operating systems to support and facilitate the configuration of device drivers of wireless network interface controllers and related aspects of networking using the Linux Wireless Extension. Further, the Iwlist tool can be used to scan for available wireless communication networks 105 and to display additional information about the identified networks.

In an embodiment, as illustrated in FIG. 3a and FIG. 3b, the SSID field within one of the probe request frame and the probe response frame is used to include a data header and the application data. The data header may comprise one or more fields including but not limited to the Session ID which uniquely identifies a communication session between console device 101 and one of the one or more remote devices 103. The command ID (CMD ID) is a sequence identification number which uniquely identifies the command or application data being exchanged in an established communication session.

In an exemplary embodiment where the size of the application data being exchanged exceeds a predetermined size in bytes, the application data is fragmented to smaller chunks in a way that the size of the application data in addition to the size of the data header does not exceed the predetermined size in bytes. As an example, the predetermined size for fragmenting the application data may be 8 bytes, 16 bytes or 32 bytes. In one embodiment, each of the fragmented smaller chunks is pre-fixed with the data header. The data header comprises a Fragment ID for indicating the fragment number and also the number of pending fragments to be transmitted. As an example, the fragment ID of 3 indicates that a specific chunk of data is the third fragment in the frame and there are 3 more fragments, having fragment ID=2, 1 and 0, pending to complete the exchange of a complete message, MSG. Similarly, the fragment ID of 0 indicates that a specific fragment is the last fragment pending for transmission. The CMD ID remains same for the one or more fragments of the same command data being exchanged. In an embodiment, the fragment ID is assigned a value of zero by default.

In an alternative embodiment, as shown in FIG. 3b, for exchanging application data having size more than a predetermined size in bytes, the data header field may be included within the SSID field and the actual application data may be included as a vendor specific information element (Vendor Specific IE) field configured in the frame body without the need for fragmenting the data into smaller chunks.

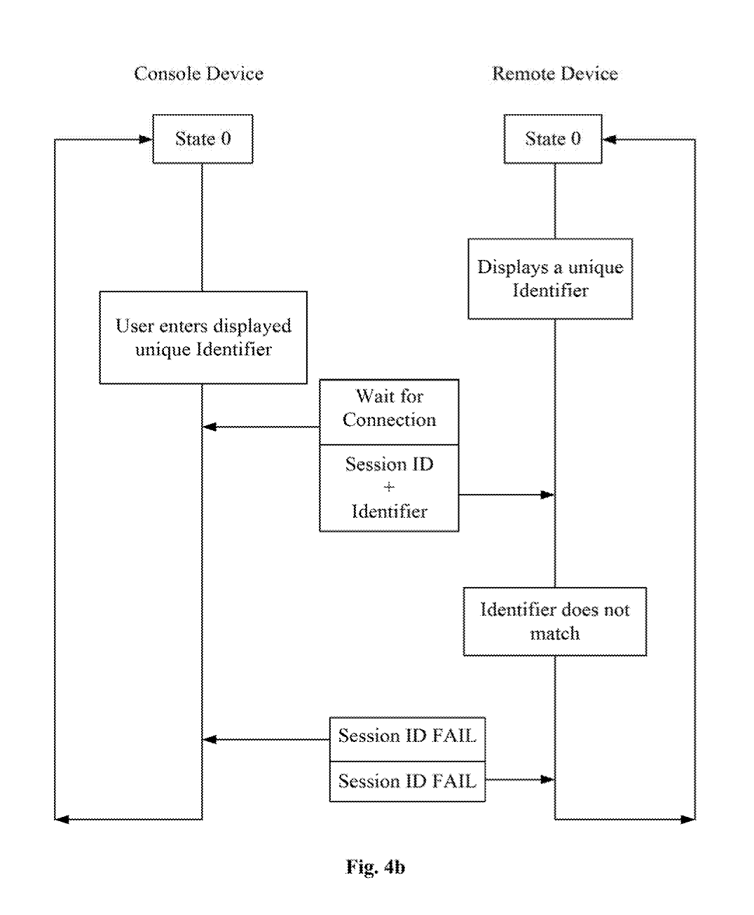

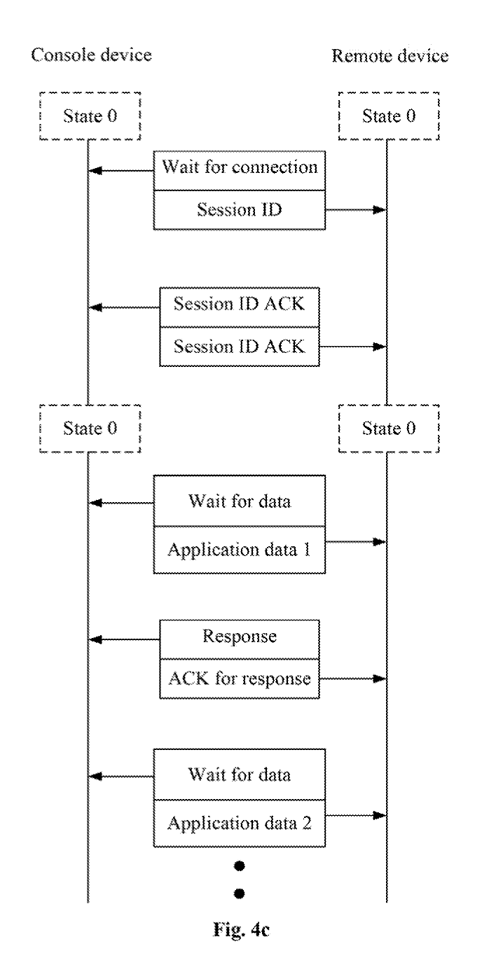

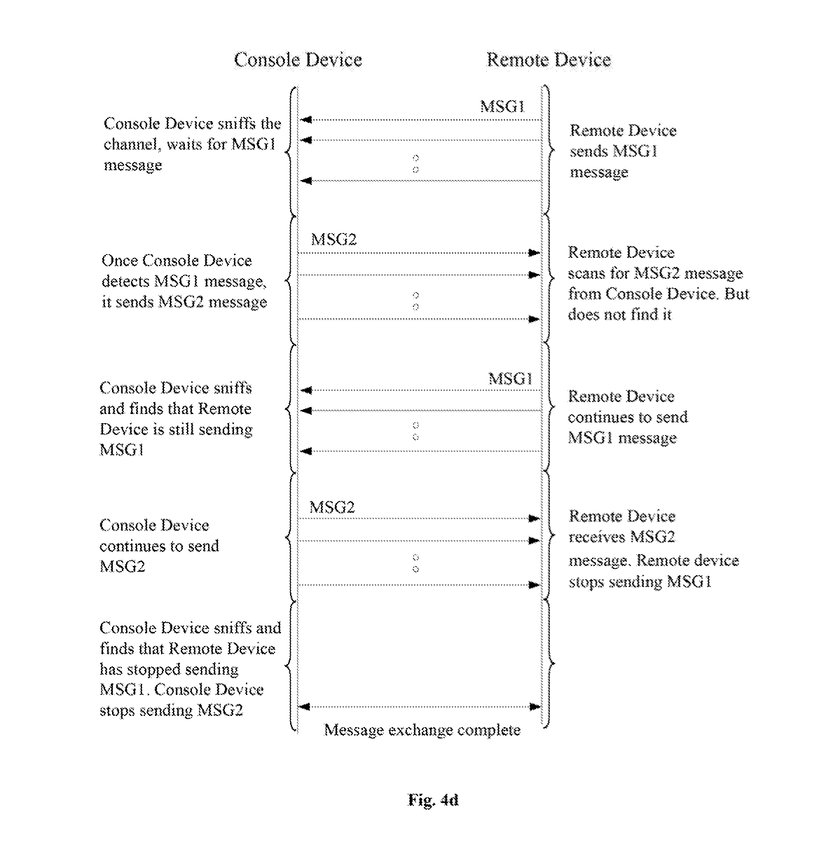

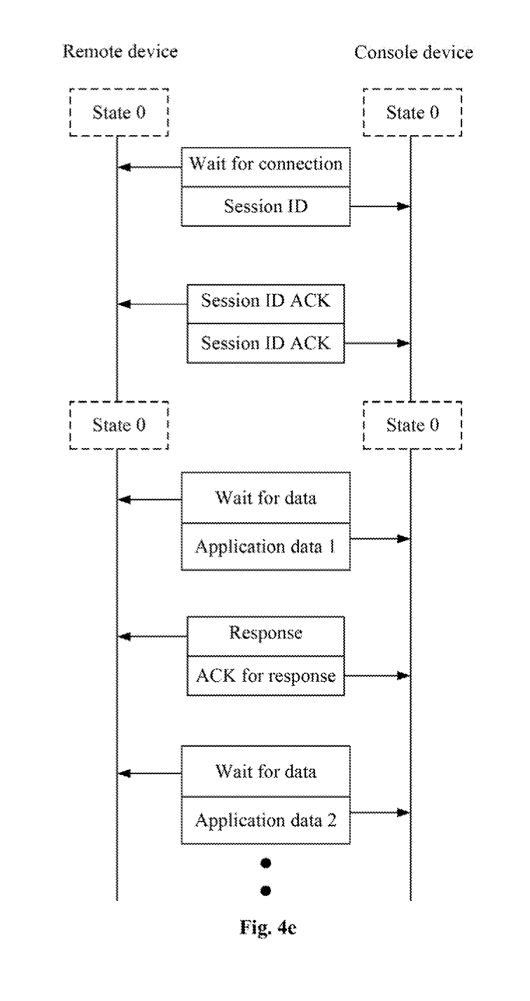

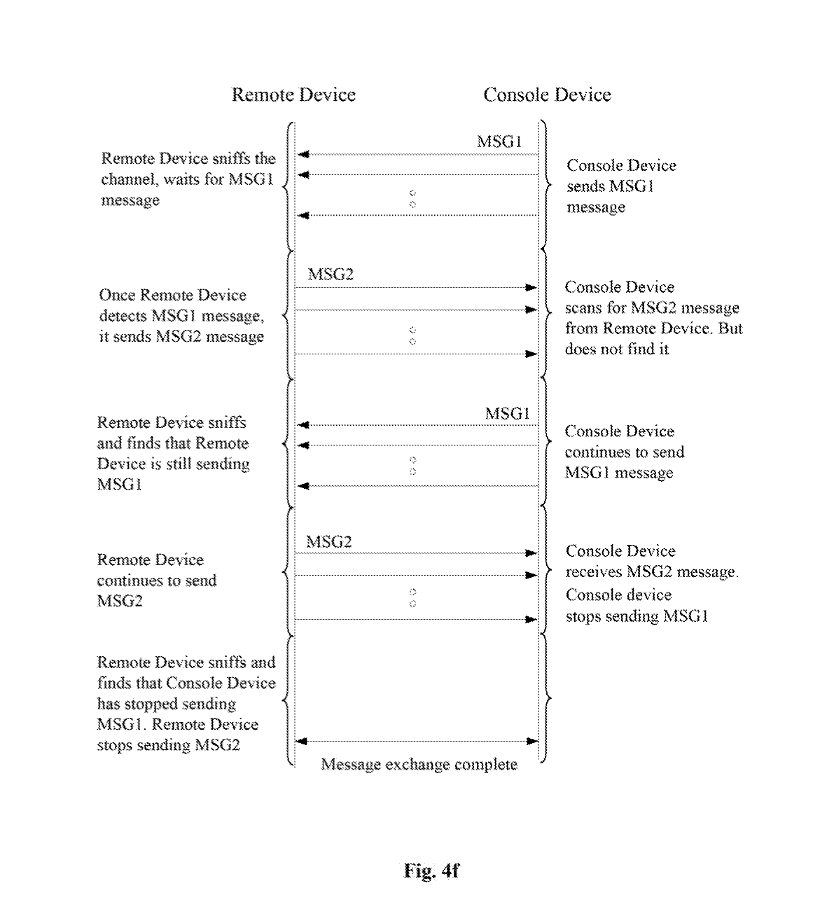

FIG. 4a and FIG. 4b illustrate the method of authentication between the console device and one of the one or more remote devices.

In an embodiment, upon initialization of the console device 101 and one of the remote devices 103, the remote device 103 may display a randomly unique identification number on its Remote User application 235. The console device 101 upon initialization, requests for the unique identification number generated by the remote device 103 to identify the remote device 103 in the network 105. In an embodiment, a user of the console device 101 may manually enter the unique identification number displayed on the Remote User application 235 of the remote device 103. Upon receiving the unique identification number, the console device 101 retransmits the unique identification number along with a unique Session ID in response to “Wait for connection” message from remote device 103.

In an embodiment, the remote application 233 present on the remote device 103 compares the unique identification number received from the console device 101 with the unique identification number displayed on its Remote User application 235. If the numbers match, the remote device 103 transmits a Session ID ACK to the console device 101, thereby completing the authentication process. A communication session is established between the console device 101 and the remote device 103 after the authentication.

In an alternative embodiment, as shown in FIG. 4b, if the unique identification numbers does not match, the remote device 103 transmits a Session ID FAIL message and both the remote device 103 and the console device 101 go back to the initialization state, the state 0. Further, a new unique identification number may be generated and displayed at the remote device 103 in order to retry the authentication process. The aforementioned process may be repeated until the authentication process is successful or a predetermined number of iterations are completed. As an example, the predetermined number of iterations may be five, meaning that each of the console device 101 and the remote device 103 can attempt the authentication for a maximum of five times.

In a further embodiment, the remote device 103, in addition to comparing the displayed unique identification number, may also check for its proximity with the console device 101. As an example, a proximity sensing mechanism may be incorporated in each of the console device 101 and the remote device 103 to detect the proximity of the remote devices 103 with the console device 101. The remote device 103 transmits a Session ID ACK to the console device 101 upon detecting that the console device 101 is in the proximity of the remote device 103. In an embodiment, the remote device 103 may also notify the user of the console device 101 to perform one or more actions, such as, moving the console device 101 closer to the remote devices 103 in order to have the console device 101 in the proximity of the remote device 103.

The authentication mechanism ensures that the console device 101 and the remote device 103 connect to the intended peer and not to some unauthorized or harmful device. Once the console device 101 and the remote device 103 are in state 1, they will ignore frames received from the unauthenticated or harmful devices.

FIG. 4c illustrates the method of establishing a communication session between the console device and the one of one or more remote devices.

In an embodiment, a communication session may be established between the console device 101 and the remote device 103 by defining a sequence of data exchange between the console device 101 and the remote device 103. Once the session is established, one to one data exchange between the console device 101 and the identified one of one or more remote devices 103 may be achieved. The initial state of the console device 101 and the identified one of the one or more remote devices 103 is called state 0. In the state 0, the console device 101 and the remote device 103 are not authenticated and no communication session can be established.

In an embodiment, upon initializing, the remote device 103 sends a “Wait for connection” message to the console device 101. The “Wait for connection” message provides an indication to the console device 101 that the remote device 103 is waiting for a connection from the console device 101. The console device 101 transmits a unique Session ID to the identified remote device 103 once it detects the “Wait for connection” message from the remote device 103. Upon receiving the Session ID from the console device 101, the remote device 103 further transmits a Session ID ACK to the console device 101 to confirm the reception of Session ID.

In an embodiment, the remote device 103 may transmit the Session ID ACK only if the console device 101 meets one or more predetermined criteria. As an example, one of the predetermined criteria can be a guarantee that the console device 101 receives a unique identification number associated with the remote device 103 with a minimum delay in transmission. In an alternative embodiment, the remote device 103 might ignore the Session ID received from the console device 101 if the console device 101 does not meet the predetermined criteria. The console device 101, in such a case, may wait for the Session ID ACK till a predetermined timeout period is reached and then may go back to state 0. Alternatively, if the console device 101 receives the Session ID ACK from the remote device 103, the console device 101 may transmit the Session ID ACK to the remote devices 103 to confirm the reception of Session ID ACK. The communication session between the console device 101 and the remote device 103 is considered to be established when both the console device 101 and the remote device 103 exchange the Session ID ACK. Therefore, both the console device 101 and the remote device 103 now move to state 1.

In state 1, the console device 101 and the remote device 103 are ready to exchange the application data. In state 1, the remote device 103 transmits a “wait for data” message. The “wait for data” message provides an indication to the console device 101 that the remote device 103 is waiting for a command or application data from the console device 101. The console device 101, in turn, responds with the command or application data when it detects the “wait for data” message. The remote device 103, upon receiving the command or application data from the console device 101, may transmit a response to the console device 101. Upon receiving the response from the remote device 103, the console device 101 sends an ACK for the received response.

In an embodiment, the remote device 103 may further transmit one or more subsequent “Wait for data” message to the console device 101 in order to receive further commands and application data from the console device 101. The aforementioned process is repeated until the complete application data is exchanged.

In an embodiment, the method as disclosed in FIG. 4c is not limited to a remote device 103 sending the “Wait for connection” and a console device 101 sending the Session ID. Alternatively, as shown in FIG. 4e, the console device 101 may also send the “Wait for connection” message and the remote device 103 may also send the corresponding Session ID. Similarly, the method as disclosed in FIG. 4c is not limited to the remote device 103 sending the “Wait for data” and the console device 101 sending the command or application data. Alternatively, as shown in FIG. 4e, the console device 101 may also send the “Wait for data” message and the remote device 103 may also transmit the one or more command or application data in response to the “Wait for data” message from the console device 101.

FIG. 4d shows a sequence diagram illustrating a method of exchanging application data between the console device and the remote device in accordance with some exemplary embodiments of the present disclosure.

In an exemplary embodiment, let MSG1 represent a particular command or application data contained within the data field of at least one of the probe request frame and the probe response frame transmitted by one of the one or more remote devices 103 to the console device 101. Similarly, let MSG2 represent a command or application data contained within the data field of at least one of the probe response frame and the probe request frame transmitted by the console device 101 to one of the one or more remote devices 103.

In an embodiment, the console device 101 continuously sniffs the wireless communication network 105 for receiving MSG1 from one of the one or more remote devices 103 using the packet sniffer 215. The console device 101 continues to wait for MSG1 until it receives MSG1 from one of the one or more remote devices 103. The console device 101 further transmits a message, MSG2 using at least one of the probe request frame and the probe response frame once it detects the MSG1 transmitted by the remote device 103. The console device 101 then sniffs the wireless communication network 105 and checks for MSG1 message from the remote device 103. If the remote device 103 continues to send MSG1, it implies that the remote device 103 did not receive MSG2. Therefore the console device 101 continues to retransmit the MSG2 and checks the wireless communication network 105 repeatedly for MSG1. Alternatively, if the remote device 103 receives the MSG2 message from console device 101, then the remote device 103 stops transmitting MSG1 to the console device 101. This serves as an acknowledgement to the console device 101 that the remote device 103 has successfully received the MSG 1. Furthermore, the console device 101 may sniff the communication channel to make sure that the remote device 103 has stopped sending MSG1 and the console device 101, in turn, may stop sending MSG2. The aforementioned sequence of controls between the console device 101 and the identified one or more remote device 103 completes the exchange of MSG1, MSG2 between the console device 101 and the identified one or more remote device 103.

In an embodiment the identified remote device 103 and the console device 101 might send multiple frames, having MSG1 and MSG2, for transmission of each application data. This is to ensure that either the console device 101 or the remote device 103 may receive the frame with a minimum time delay.

In an embodiment, the method as disclosed in FIG. 4d is not limited to a remote device 103 sending the MSG1 and a console device 101 sending the MSG2. Alternatively, as shown in FIG. 4f, the console device 101 may also transmit the MSG1 and the remote device 103 may also transmit the MSG2. Similarly, the method disclosed in FIG. 4d is not limited to using unicast probe request frame and unicast probe response frame. Instead, the console device 101 and the remote device 103 may perform the data exchange by using a broadcast probe request frame and a broadcast probe response frame.

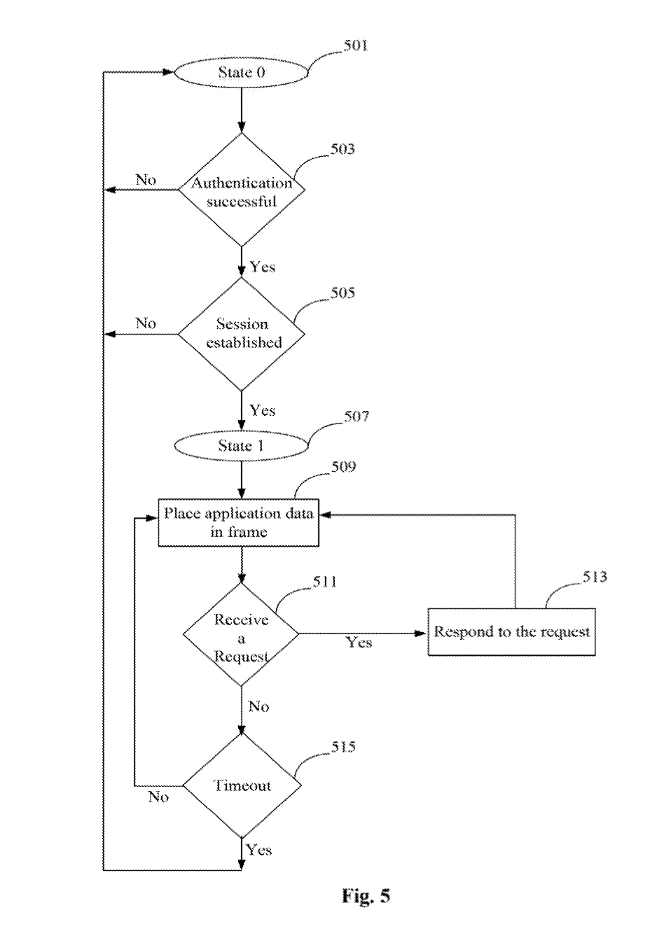

FIG. 5 illustrates a general flowchart showing method of exchanging application data between a console device and one or more remote devices in accordance with some embodiments of the present disclosure.

Accordingly, in an embodiment as shown in step 501, during the initialization, both the console device 101 and the remote device 103 are in state 0. At state 0, the remote device 103 transmits a “Wait for connection” message to the console device 101. The console device 101 may transmit a unique Session ID upon receiving the “Wait for connection” message from the remote device 103. Further, the remote device 103 and the console device 101 exchange a Session ID ACK, thus completing the authentication process and establishing a communication session, as in step 503. At step 505, the console device 101 and the remote device 103 may check for the established communication session. Upon detecting the successful establishment of the communication session, both the console device 101 and the remote device 103 move to state1 as shown in step 507. Alternatively, if one of the authentication process and establishing the communication session fails, the console device 101 and the remote device 103 revert to their initial state, state 0 of step 501.

In state 1, step 507, the remote device 103 may wait to receive one or more command or application data from the console device 101. The console device 101 upon reaching state 1 places the application data, to be exchanged with the remote device 103, on at least one of the probe request frame and the probe response frame step 509 and transmits the frames to the remote device 103 as shown in step 511. The remote device 103 performs one or more actions on the received one or more commands and the application data and transmits a response to the console device 101 using at least one of the probe request frame and the probe response frame as in step 513. In an embodiment, if the remote device 103 does not receive any data from the console device 101 or the console device 101 does not receive any response from the remote device 103 before a predetermined timeout period step 513, the console device 101 and the remote device 103 revert to State 0 step 501. Further, a new communication session may have to be established again before exchanging the application data.

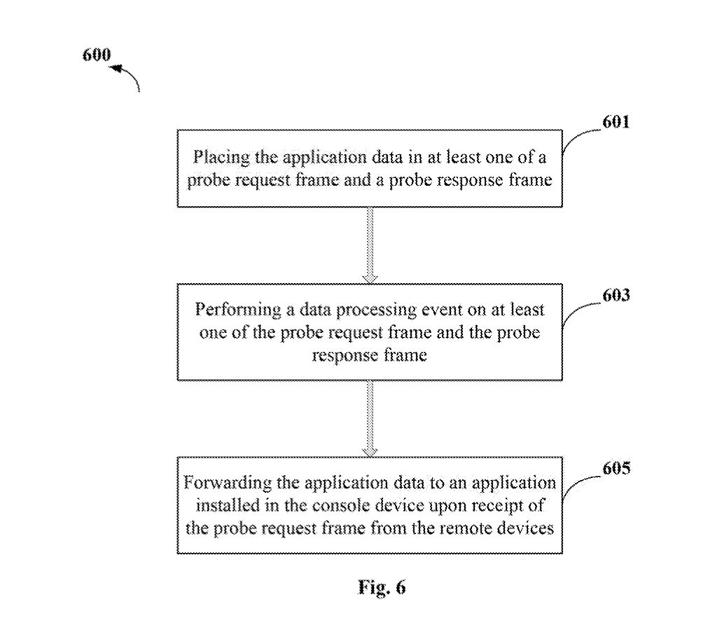

FIG. 6 illustrates a flowchart showing method of exchanging application data between a console device and one or more remote devices in accordance with some embodiments of the present disclosure.

As illustrated in FIG. 6, the method 600 comprises one or more blocks for exchanging application data between a console device 101 and one or more remote devices 103 in one of the associated and non-associated state. The method 600 may be described in the general context of computer executable instructions. Generally, computer executable instructions can include routines, programs, objects, components, data structures, procedures, modules, and functions, which perform particular functions or implement particular abstract data types.

The order in which the method 600 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 601, the console device 101 places the application data in at least one of a probe request frame and a probe response frame. The application data placed in at least one of the probe request frame and the probe response frame is the data that has to be exchanged between the console device 101 and the remote device 103. In an embodiment, the application data exchanged between the console device 101 and the one or more remote devices 103 is placed within a Service Set Identifier (SSID) field of the probe request frame and the probe response frame. Further, one or more additional information related to the application data are placed within a data header field in the SSID field of the probe request frame and the probe response frame. The one or more additional information related to the application data may include but not limited to, a unique session identification number, sequence number of the transmitted application data, fragment number and the number of fragments of application data pending to be transmitted.

At block 603, the console device 101 performs a data processing event on at least one of the probe request frame and the probe response frame, wherein the data processing event includes receiving the probe request frame from the one or more remote devices 103 and transmitting the probe response frame to the one or more remote devices 103. In an embodiment, a communication session may be established between the console device 101 and the one or more remote devices 103 using the probe request frame and the probe response frame.

At block 605, the console device 101 forwards the application data to a console user application 223 installed in the console device 101, upon receipt of the probe request frame from the one or more remote devices 103. In an embodiment, the console device 101 may fragment the application data into one or more smaller fragments before placing the application data in the SSID field when size of the application data exceeds a predetermined data size. Alternatively, the application data may be placed within a vendor specific field in the probe response frame and the probe request frame when the size of the application data is more than a predetermined data size.

### Computer System

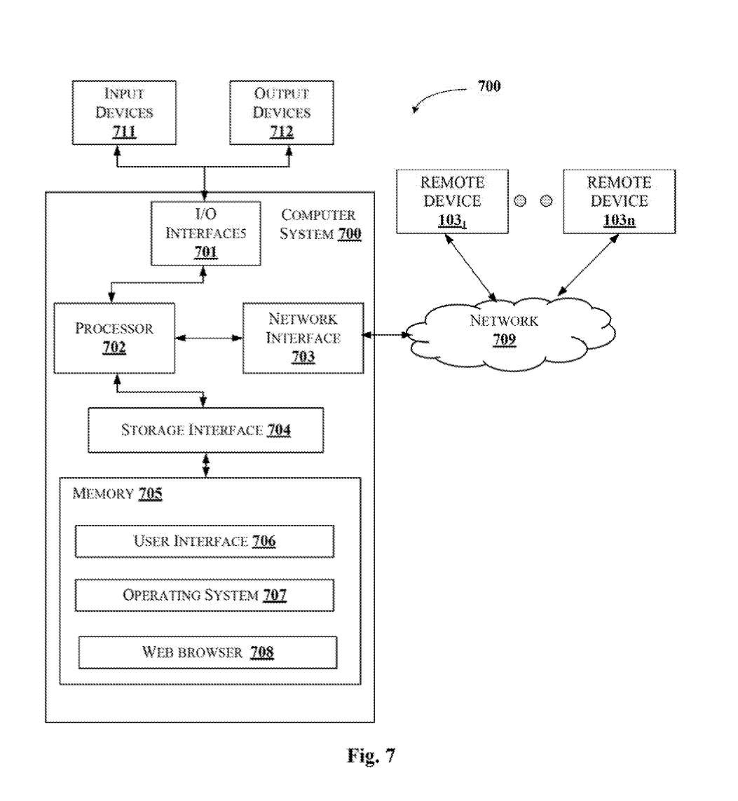

FIG. 7 illustrates a block diagram of an exemplary computer system 700 for implementing embodiments consistent with the present invention. In an embodiment, the computer system 700 is used for exchanging application data between a console device 101 and one or more remote devices 103, over an air interface 105. The computer system 700 may comprise a central processing unit (“CPU” or “processor”) 702. The processor 702 may comprise at least one data processor for executing program components for executing user- or system-generated business processes. A user may include a person, a person using a device such as such as those included in this invention, or such a device itself. The processor 702 may include specialized processing units such as integrated system (bus) controllers, memory management control units, floating point units, graphics processing units, digital signal processing units, etc.

The processor 702 may be disposed in communication with one or more input/output (I/O) devices (711 and 712) via I/O interface 701. The I/O interface 701 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE), WiMax, or the like), etc.

Using the I/O interface 701, the computer system 700 may communicate with one or more I/O devices (711 and 712).

In some embodiments, the processor 702 may be disposed in communication with a communication network 709 via a network interface 703. The network interface 703 may communicate with the communication network 709. The network interface 703 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 703 and the communication network 709, the computer system 700 may communicate with one or more remote devices 710 (a, . . . , n). The communication network 709 can be implemented as one of the different types of networks, such as intranet or Local Area Network (LAN) and such within the organization. The communication network 709 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 709 may include a variety of network devices, including routers, bridges, servers, computing devices, storage devices, etc. The one or more remote devices 710 (a, . . . , n) may include, without limitation, personal computer(s), mobile devices such as cellular telephones, smartphones, tablet computers, eBook readers, laptop computers, notebooks, gaming consoles, or the like.

In some embodiments, the processor 702 may be disposed in communication with a memory 705 (e.g., RAM, ROM, etc. not shown in FIG. 7) via a storage interface 704. The storage interface 704 may connect to memory 705 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 705 may store a collection of program or database components, including, without limitation, user interface application 706, an operating system 707, web server 708 etc. In some embodiments, computer system 700 may store user/application data 706, such as the data, variables, records, etc. as described in this invention. Such databases may be implemented as fault-tolerant, relational, scalable, secure databases such as Oracle or Sybase.

The operating system 707 may facilitate resource management and operation of the computer system 700. Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), International Business Machines (IBM) OS/2, Microsoft Windows (XP, Vista/7/8, etc.), Apple iOS, Google Android, Blackberry Operating System (OS), or the like. User interface 706 may facilitate display, execution, interaction, manipulation, or operation of program components through textual or graphical facilities. For example, user interfaces may provide computer interaction interface elements on a display system operatively connected to the computer system 700, such as cursors, icons, check boxes, menus, scrollers, windows, widgets, etc. Graphical User Interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 700 may implement a web browser 708 stored program component. The web browser may be a hypertext viewing application, such as Microsoft Internet Explorer, Google Chrome, Mozilla Firefox, Apple Safari, etc. Secure web browsing may be provided using Secure Hypertext Transport Protocol(HTTPS) secure sockets layer (SSL), Transport Layer Security (TLS), etc. Web browsers may utilize facilities such as AJAX, DHTML, Adobe Flash, JavaScript, Java, Application Programming Interfaces (APIs), etc. In some embodiments, the computer system 700 may implement a mail server stored program component. The mail server may be an Internet mail server such as Microsoft Exchange, or the like. The mail server may utilize facilities such as Active Server Pages (ASP), ActiveX, American National Standards Institute (ANSI) C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 700 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

### Advantages of the Embodiment of the Present Disclosure are Illustrated Herein.

In an embodiment, the present disclosure provides a method to exchange application data between a console device and one or more remote devices wherein the one or more remote devices are in at least one of associated and non-associated state over an air interface.

In an embodiment, the present disclosure provides a method of handling packet transmission, acknowledgement and retransmission of application data using a frame loop back method.

In an embodiment, the present disclosure determines a unique structure for the Service Set Identifier (SSID) field within at least one of the probe request frame and the probe response frame.

In an embodiment, the present disclosure enables the console device and/or the one or more remote devices to broadcast the one or more messages and the application data over a communication interface.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the claims listed below.

### REFERRAL NUMERALS

| Reference | |
|---|---|
| Number | Description |
| 100 | Environment |
| 101 | Console Device |
| 103 | Remote Devices |
| 105 | Wireless Communication network |
| 207 | I/O interface |
| 209 | Processor |
| 211 | Memory |
| 213 | Packet Injector |
| 215 | Packet Sniffer |
| 221 | Console Application |
| 223 | Console user application |
| 225 | Command Line Interface |
| 233 | Remote Application |
| 235 | Remote user application |
| 237 | Standard WLAN CLI |

We claim:

1. A method for exchanging application data between a console device and one or more remote devices, over an air interface, the method comprising:
placing, by the console device, the application data in at least one of a probe request frame and a probe response frame;
performing, by the console device, a data processing event on at least one of the probe request frame and the probe response frame, wherein the data processing event includes receiving the probe request frame from the one or more remote devices and transmitting the probe response frame to the one or more remote devices; and
forwarding, by the console device, the application data to an application installed in the console device, upon receipt of the probe request frame from the one or more remote devices.

2. The method as claimed in claim 1 further comprises establishing a communication session between the console device and the one or more remote devices using the probe request frame and the probe response frame.

3. The method as claimed in claim 2, wherein the application data is exchanged between the console device and the one or more remote devices within a predetermined time period in the established communication session.

4. The method as claimed in claim 1, wherein the application data exchanged between the console device and the one or more remote devices is placed within a Service Set Identifier (SSID) field of the probe request frame and the probe response frame.

5. The method as claimed in claim 1, wherein one or more additional information related to the application data are placed within a data header field in the SSID field of the probe request frame and the probe response frame.

6. The method as claimed in claim 5, wherein the one or more additional information related to the application data may include but not limited to, a unique session identification number, sequence number of the transmitted application data, fragment number and the number of fragments of application data pending to be transmitted.

7. The method as claimed in claim 1 further comprises fragmenting the application data into one or more smaller fragments before placing the application data in the SSID field when size of the application data exceeds a predetermined data size.

8. The method as claimed in claim 1, wherein the application data is placed within a vendor specific field in the probe response frame and the probe request frame when the size of the application data is more than a predetermined data size.

9. The method as claimed in claim 1 further comprises exchanging a unique identifier between the console device and the one or more remote devices for authenticating the one or more remote devices and the console device respectively using the probe request frame and the probe response frame.

10. The method as claimed in claim 9, wherein the console device and the one or more remote devices are authenticated using the Probe request and Probe response frame upon detecting the console device within proximity of the one or more remote devices.

11. The method as claimed in claim 1, wherein the console device transmits the probe response frame to the one or more remote devices for enabling the one or more remote devices to forward the application data to an application installed in each of the one or more remote devices.

12. A console device for transmitting the application data to one or more remote devices, over an air interface, the console device comprising:
a processor; and
a memory communicatively coupled to the processor, wherein the memory stores processor-executable instructions, which, on execution, causes the processor to:
place the application data in at least one of a probe request frame and a probe response frame;
performing a data processing event on at least one of the probe request frame and the probe response frame, wherein the data processing event includes receiving the probe request frame from the one or more remote devices and transmitting the probe response frame to the one or more remote devices; and
forwarding the application data to an application installed in the console device, upon receipt of the probe request frame from the one or more remote devices.

13. The console device as claimed in claim 12, wherein the probe request frame and the probe response frame are used to establish a communication session between the console device and the one or more remote devices.

14. The console device as claimed in claim 13, wherein the console device and the one or more remote devices exchange the application data within a predetermined time period in the established communication session.

15. The console device as claimed in claim 12, wherein a Service Set Identifier (SSID) field in the probe request frame and the probe response frame is used to place the application data exchanged between the console device and the one or more remote devices.

16. The console device as claimed in claim 12, wherein a data header field in the SSID field of the probe request frame and the probe response frame is used to place one or more additional information related to the application data.

17. The console device as claimed in claim 16, wherein the one or more additional information related to the application data may include but not limited to, a unique session identification number, sequence number of the transmitted application data, fragment number and the number of fragments of application data pending to be transmitted.

18. The console device as claimed in claim 12, wherein the application data is fragmented the into one or more smaller fragments before placing the application data in the SSID field when size of the application data exceeds a predetermined data size

19. The console device as claimed in claim 12, wherein a vendor specific field in the probe request frame and the probe response frame is used to place the application data when the size of the application data is more than a predetermined data size

20. The console device as claimed in claim 12, wherein the probe request frame and the probe response frame are further used exchange a unique identifier between the console device and the one or more remote devices for authenticating the one or more remote devices and the console device respectively.

21. The console device as claimed in claim 20, wherein the console device and the one or more remote devices are authenticated using the Probe request and Probe response frames upon detecting the console device within proximity of the one or more remote devices.

22. The console device as claimed in claim 12, wherein the console device transmits the probe response frame to the one or more remote devices for enabling the one or more remote devices to forward the application data to an application installed in each of the one or more remote devices.
